(19) United States
(12) Patent Application Publication
(10) Pub. No.: US 2011/0298234 A1
(43) Pub. Date: Dec. 8, 2011

(54) DEVICE FOR GRIPPING A HOLLOW BODY BY THE NECK THEREOF

(75) Inventors: Damien Cirette, Octeville Sur Mer (FR); Christophe Doudement, Octeville Sur Mer (FR)

(73) Assignee: SIDEL PARTICIPATIONS, Octeville Sur Mer (FR)

(21) Appl. No.: 13/201,481

(22) PCT Filed: Feb. 16, 2010
(86) PCT No.: PCT/EP2010/051902

§ 371 Date: Aug. 15, 2011

(30) Foreign Application Priority Data
Feb. 27, 2009 (FR) 0951246

(51) Int. Cl. B66C 1/48; B25J 15/00

(52) U.S. Cl. 294/197; 294/104

(57) ABSTRACT

A device (10) for gripping a hollow body (12) having a tubular neck (16), the device (10) includes a back plate (38) defining an axial bearing surface (40), a head (34) delimiting a radial bearing surface (50), a locking catch (54) supported by the head (34), characterised in that the head (34) is movably mounted between a locking position of the neck (16), in which the locking catch (54) bears on an inner surface (58) of the neck (16), such that the bearing surfaces (40, 50) define an so-called gripping area (Z), and an unlocking position (16) of the neck, in which the catch (54) is removed from the gripping area (Z).

The invention relates to a device for gripping a hollow body, in particular a hollow body provided with a neck.

The invention relates more particularly to a device for gripping a hollow body, the hollow body having a body which is closed at the bottom and a tubular neck which extends axially along an axis A and which has a radial annular lip defining an opening, the device having:
a backpiece defining a support surface which extends axially,
a head defining a support surface which extends radially and at right angles to the support surface of the backpiece,
a locking finger which is carried on the head, protrudes axially with respect to the support surface of the head and delimits a counter-support surface.

The invention lies in the field of manufacturing hollow bodies made of thermoplastic, said manufacturing involving primarily the injection-molding of a preform which is heat treated in an oven and which is then formed by means of a blow-molding machine, during a blow-molding or stretch-blow-molding step, in order to obtain the final container.

The expression “hollow body” is understood to mean a container preform, or else a final container, or optionally an intermediate container, i.e. any type of hollow body having a body from which there extends an open-ended tubular neck.

In the rest of the document the term preform will be used by way of preference and in a nonlimiting manner.

The preform obtained by injection-molding has generally a tubular cylindrical body which is closed at one of its axial ends and which is prolonged at its other end by a neck, which is also tubular.

The neck extends axially from a main annular flange, which is arranged at the junction between the neck and the body of the preform, as far as an annular lip, which delimits an axial opening in the neck.

The neck is generally injection-molded so as to already have its final form, whereas the body of the preform is intended to undergo plastic deformation in order to form the final container, following the blow-molding operation.

In order to be able to carry out this blow-molding operation, it is necessary for the body of the preform to be brought to a temperature higher than the glass transition temperature of the material.

To this end, a heat treatment of the preform is carried out by passing it through the inside of a furnace by means of an endless transporting device, following a heating path.

The furnace comprises heating means which consist for example of infrared lamps, in front of which the preform is moved by the transporting device.

However, during the transport of the preform inside the furnace, the neck of the preform has to be heated as little as possible in order that the neck is not deformed since it already has its final form.

The preforms are generally held on the transporting device by a gripping device.

To this end, the preform is transferred, or loaded, at the entrance into the furnace by transfer means from a preform supplying device to the gripping device in the furnace.

The operation of transferring a preform from the transfer means to the gripping device is known as “donning”.

In the same manner, at the outlet from the furnace, the heated preform is transferred, or unloaded, by additional transfer means from the gripping device to the preform blow-molding machine.

A distinction is drawn between the axial transfer of the preform from the transfer means to the gripping device and the radial transfer of the preform from the transfer means to the gripping device.

Contrary to the radial transfer, the axial transfer requires an axial rising and falling movement of the gripping device with respect to the transfer means, this movement being detrimental to the rate of transfer of the preforms.

Radial transfer is carried out for example by a radial transfer means which has a transfer wheel.

The transfer wheel is mounted such that it can rotate about a vertical axis and it delimits a plurality of radially open housings, in each of which there is arranged a preform such that each preform can be transferred radially from the wheel to the preform gripping device.

However, certain types of devices for gripping the preform are not compatible with a radial transfer means, in particular a gripping device of the type having a moving finger, such as the one described in document FR-A-2 857 287.

This gripping device has a backpiece which delimits an axial support surface for the radial support of an outer surface of the neck of the preform.

In a complementary manner, the gripping device has a locking finger which delimits a counter-support surface and a head which delimits a radial support surface.

The locking finger is carried on the head such that it can move between an unlocked position, in which the finger is retracted, and a locked position, in which the finger protrudes from the support surface of the head in order to engage with the inner surface of the neck in order to lock the neck, such that the wall of the neck is clamped between the locking finger and the backpiece and the radial support surface of the head is axially supported on the lip of the neck of the preform.

The gripping device having a moving finger is not entirely satisfactory since it is in particular not able to engage with a radial transfer means.

This is because, during radial transfer of the preform toward the gripping device having a moving finger, the support surface of the head and the lip of the neck of the preform extend in one and the same radial plane, such that following the radial transfer the lip is axially supported against the support surface of the head provided to this end.

Consequently, during such a radial transfer, either the neck of the preform radially strikes one edge of the head, or the neck of the preform is axially spaced apart from the support surface of the head, in which case the preform risks being held poorly.

Thus, in order to enable the radial transfer of the preform toward the gripping device having a moving finger, the relative axial position of the head of the device and the neck of the preform must be precise.

However, such precision is difficult to attain in the light of the very high rates of transfer of the preforms toward the gripping devices.

The invention aims in particular to enable the radial transfer of the preform toward the gripping device while avoiding the abovementioned problems and providing effective locking, or coupling, of the preform to the gripping means, even at a high rate of transfer.

To this end, the invention provides a gripping device of the above-described type, characterized in that the head is mounted such that it can move with respect to the backpiece between at least a position in which the neck is locked, in which the radial support surface of the head is axially supported on at least a portion of the lip of the hollow body, the axial support surface of the backpiece is radially supported on the outer surface of the neck and the counter-support surface of the locking finger is supported on an inner surface of the neck, such that said support surfaces delimit between one another what is known as a gripping region for gripping said neck, in which the neck is clamped and locked between the backpiece and the locking finger, and a position in which the neck is unlocked, in which the assembly formed by the locking finger and the head is moved apart from the gripping region in order to unlock the neck and to make it possible to remove and introduce the neck of the hollow body from and/or into the gripping region.

According to further features of the invention:
the head is mounted such that it can pivot with respect to the backpiece about a radial axis B at right angles to the backpiece;
the counter-support surface of the finger has a convex form which is supported against the inner surface of the neck of the hollow body, opposite the backpiece, when the head is in its locked position;
the locking finger and the head are connected together for the purposes of movement, such that the counter-support surface of the locking finger is automatically supported on the inner surface of the neck when the head is driven from its unlocked position into its locked position;
in its locked position, the head is arranged such that it closes off the opening in the neck of the hollow body so as to prevent contaminating particles entering the inside of the hollow body;
the backpiece has a blocking edge which extends radially and is intended to be axially supported against an annular radial flange of the neck when the head is in its locked position, such that the neck is blocked axially between said blocking edge of the backpiece and the support surface of the head;
the backpiece delimits a rib which protrudes radially from the support surface of the backpiece, the rib being able to engage with a complementary groove in the neck of the hollow body when the head is in its locked position, such that the groove in the neck is axially blocked by the rib on the backpiece;
the rib on the backpiece has a beveled form having a section that more or less decreases in a radial direction toward the gripping region in order to enable the rib to be introduced radially into the associated groove in the neck;
the head has means for cooling by dissipation of heat;
the device has actuating means for selectively moving the head between its locked position and its unlocked position.

Further features and advantages of the invention, and also design and production details will become apparent from reading the following detailed description, in order to understand which reference is made to the appended drawings, in which:

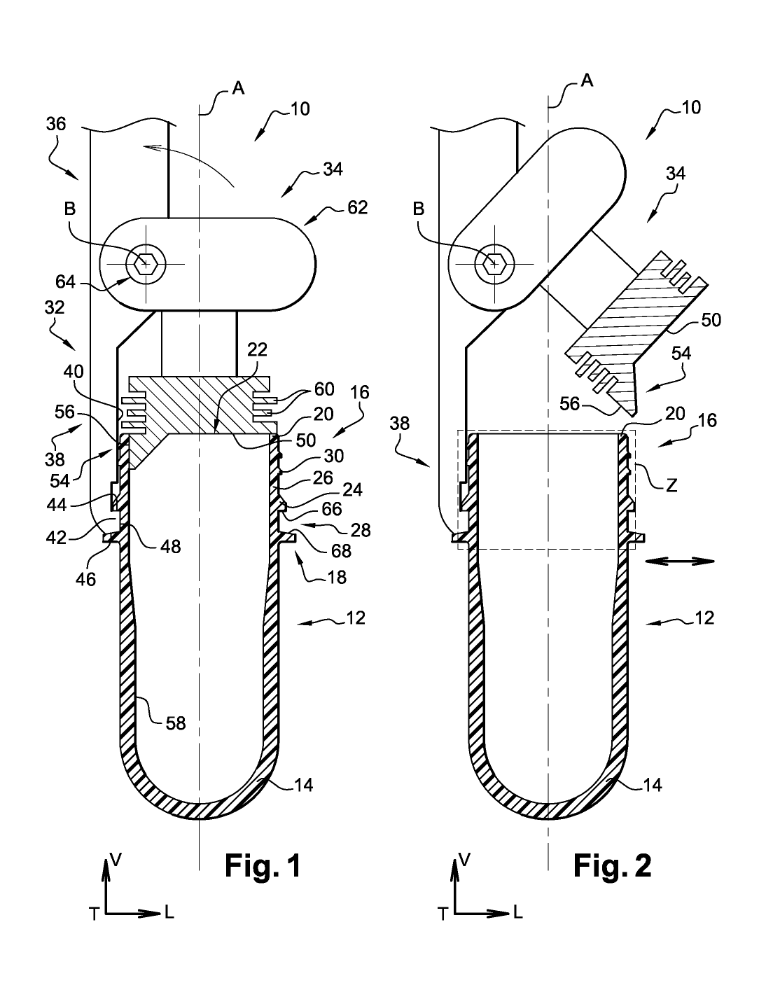

FIG. 1 is an axial section view along the axis A, illustrating a gripping device which has a head in the position in which the neck of a preform according to the invention is locked;

FIG. 2 is an axial section view along the axis A, illustrating the gripping device from FIG. 1, the head of which is in a position in which the neck of the preform is unlocked;

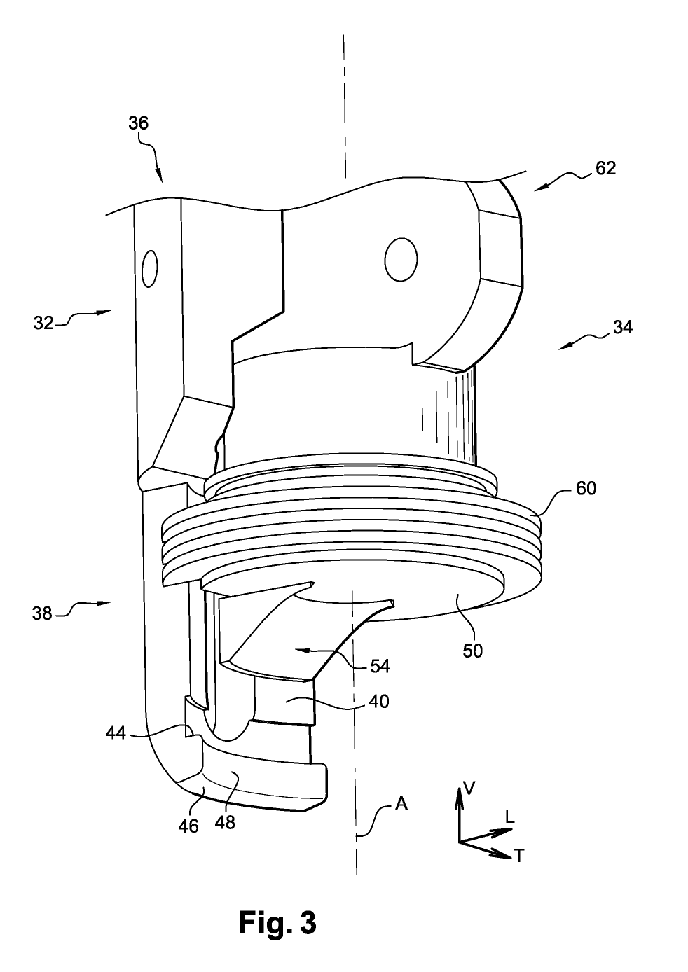

FIG. 3 is a perspective view illustrating the gripping device from FIG. 1, the head of which is in its position in which the neck of the preform is locked.

In the description and the claims, use will be made, by convention and in a nonlimiting manner, of the terms “axial”, “upper” and “lower” with regard to the vertical direction and without reference to gravity, and the longitudinal, vertical and transverse directions will be used with reference to the (L, V, T) trihedral frame indicated in the figures.

Also, use will be made of the terms “rear” and “front” with reference to the left-hand part and the right-hand part, respectively, of FIGS. 1 and 2.

However, these concepts should not be interpreted as limiting the scope of the invention, particularly since there are known transporting devices which, after gripping the preform which is oriented with the neck upward, rotate such that the preform passes with the neck at the bottom in front of the heating means, before being turned up again in order to be unloaded.

FIG. 1 shows a device 10 for gripping a preform 12, which is intended to be fitted on a device (not shown) for transporting the preform 12.

The transporting device is intended to pass the preform 12 through the inside of a heat treatment furnace with a view to subsequently blow-molding or stretch-blow-molding the preform 12 in order to obtain a container, for example a bottle.

The invention will be applied in particular in installations for blow-molding containers made of polyethylene terephthalate (PET), in which preforms which have previously been injection-molded are conveyed into the heat treatment furnace and then toward a blow-molding device.

The device for transporting preforms is, for example, provided with a chain comprising a number of links which are hinged together and are each connected to a gripping device 10.

The chain rotates inside the furnace in a closed circuit and, at the entrance to the furnace, there are provided means for transferring, or loading, the preform 12 onto the gripping device 10 and, at the outlet from the furnace, there are provided additional means for transferring, or unloading, the preform 12 from the gripping device 10.

The transporting device is thus able to pass the preform 12 through the inside of the furnace along a predetermined heating path, along which the preform 12 passes in front of heating means such as infrared lamps.

In order that the heating of the preform 12 is homogeneous enough, it is known to rotate the preform 12 on itself about its axis A, along the entire heating path in front of the heating means.

To this end, the device 10 for gripping the preform 12 is connected in terms of rotation to means (not shown) for rotating about the vertical axis A.

The preform 12 has a tubular cylindrical body 14 which is closed at its lower axial end by a hemispherical portion and which is prolonged at its upper axial end by a neck 16, which is also tubular.

The neck 16 extends axially along the axis A from a main annular flange 18 to a radial annular lip 20 which delimits an axial opening 22 in the neck 16, the opening 22 enabling access to the internal volume of the preform 12.

The main flange 18, which is located at the junction between the neck 16 and the body 14 of the preform 12, extends about the axis A and protrudes radially from an outer surface 26 of the neck 16.

Similarly, the neck 16 has here a secondary flange 24 which extends about the axis A and which protrudes radially from an outer surface 26 of the neck 16.

The secondary flange 24 is arranged above the main flange 18, such that the two flanges delimit between one another an annular groove 28 which is intended to hold a tamperproof ring for a closure cap (not shown).

In a complementary manner, the outer surface 26 of the neck 16 has a thread 30 for the subsequent fitting of the cap.

As can be seen in FIG. 1, the gripping device 10 essentially consists of a mount 32 and a head 34.

The mount 32 extends axially from bottom to top, from a driving portion 36 to a backpiece 38.

The driving portion 36 has coupling means (not shown) which are intended to engage with a complementary portion of the transporting device, such that the gripping device is rotated about the axis A and moved in the furnace along the heating path.

The coupling means are for example produced by screwing, by cooperating shapes, or by another known coupling means.

As can be seen from FIG. 3, the backpiece 38 has the form of a portion of a cylinder which extends about the vertical axis A and which is delimited toward the front by an axial support surface 40 in order to radially support the outer surface 26 of the neck 16 of the preform 12.

In addition, the backpiece 38 has a concave rib 42 which extends about the axis A and protrudes radially toward the front from the support surface 40 of the backpiece 38.

The rib 42 has a form complementary to the form of the groove 28 in the neck 16 of the preform 12, such that the rib 42 is able to be held radially in the groove 28 in order to axially block the neck 16 of the preform 12 with respect to the mount 32.

More particularly, the rib 42 has a beveled form having a section that more or less decreases radially toward the front, the rib 42 being delimited axially by an upper blocking edge 44 and a lower blocking edge 46, and radially by a front edge 48.

According to FIG. 1, the head 34 of the gripping device 10 has a lower part which is generally cylindrical about the axis A and is delimited axially downward by a radial support surface 50.

The radial support surface 50 of the head 34 extends at right angles to the axial support surface 40 of the backpiece 38, such that the lip 20 of the neck 16 of the preform 12 is able to be axially supported upwardly against the support surface 50 of the head 34.

In addition, the head 34 has a locking finger 54 which protrudes axially downward from the support surface 50 of the head 34.

The locking finger 54 has a counter-support surface 56 which extends axially and is able to be radially supported toward the rear against an inner surface 58 of the neck 16 of the preform 12, opposite the front support surface 40 of the backpiece 38.

To this end, the counter-support surface 56 has a convex form of a portion of cylinder complementary to the form of the inner surface 58 of the neck 16.

According to another aspect, the head 34 is provided with cooling means in order to dissipate the heat absorbed by the head 34.

The cooling means comprise a plurality of fins 60 which are superposed axially with respect to one another and which each extend radially, like the fins of a radiator, outside the preform 12.

According to another aspect, the head 34 of the gripping device 10 is mounted such that it can pivot with respect to the mount 32, about a transverse radial axis B, from a locked position, shown in FIG. 1, to an unlocked position, shown in FIG. 2.

To this end, the head 34 has an upper hinging part 62 which is mechanically connected to the mount 32 by means of a pin 64 for pivoting about the transverse pivot axis B, the axis B being arranged above the backpiece 38.

In a complementary manner, the gripping device 10 has actuating means (not shown) for selectively moving the head 34 between its locked position and its unlocked position.

The means for actuating the head 34 are for example mechanical means which have an axial control rod, a lower axial end of which is mounted such that it can rotate on the upper portion 62 of the head 34 about a transverse axis, and an upper axial end of which is mechanically connected to a vertical axial drive means.

The axial drive means has for example a roller which engages with a camway, such that, while the transporting device provided with the gripping device moves through the furnace, the roller moves the control rod axially vertically, as a result of which the head 34 is moved by pivoting about the axis B.

In a nonlimiting manner, the actuating means can consist of any other actuating means that can pivot the head 34, it being possible for the actuating means to be for example a pneumatic actuator, a hydraulic actuator or else an electric actuator.

In its locked position, illustrated in FIG. 1, the support surface 50 of the head 34 is axially supported vertically on the lip 20 of the neck 16 of the preform 12, the support surface 40 of the backpiece 38 is radially supported longitudinally on the outer surface 26 of the neck 16 and the counter-support surface 56 of the locking finger 54 is radially supported longitudinally on the inner surface 58 of the neck 16, toward the rear, such that the neck 16 is clamped and locked between the backpiece 38 and the locking finger 54.

When the head 34 is in its locked position, a portion of the neck 16 is radially interposed between the finger 54 and the support surface 40 of the backpiece 38, this portion of the neck 16 comprising here the thread 30 on the neck 16.

Similarly, the rib 42 on the backpiece 38 is held in the complementary groove 28 in the neck 16, without an axial clearance, such that the upper edge 44 of the rib 42 is axially supported on an inner surface 66 of the secondary flange 24, and/or the lower edge 46 of the rib 42 is axially supported on an upper surface 68 of the main flange 18.

In addition, the beveled form of the rib 42 enables the rib 42 to be radially inserted into the associated groove 28 and the neck 16 to be positioned with respect to the backpiece 38.

Finally, when the head 34 is in its locked position, the assembly consisting of the locking finger 54 and the head 34 is located in what is known as a gripping region Z.

The gripping region Z, which is shown schematically in FIG. 2 by way of a dashed line, corresponds to the region in which the neck 16 of the preform 12 is located when the neck 16 is locked by the head 34, this region Z being delimited in particular by the support surface 40 of the backpiece 38 and the support surface 50 of the head 34.

The head 34 is moved into its locked position in a manner synchronized with the radial introduction of the neck 16 of the preform 12 into the gripping region Z, with the aim of reducing the time required to lock the preform 12.

In its locked position, which is illustrated in FIG. 2, the assembly consisting of the locking finger 54 and the head 34 is moved apart from the gripping region Z in order to unlock the neck 16 and not to hamper the longitudinal radial removal or introduction of the neck 16 of the preform 12 from or into the gripping region Z.

According to an alternative embodiment, the preform 12 can be introduced axially into the gripping region Z downwardly in a vertical direction with a view to loading or unloading it by means of the gripping device 10.

To this end, the head 34 is fixed on the driving portion 36 such that the support surface 50 of the head extends horizontally and the finger 54 is mounted such that it can pivot about a transverse axis on the head 34.

Similarly, the backpiece 32 is mounted such that it can pivot about a transverse axis on the driving portion 36.

According to this alternative, the preform 12 is introduced axially downwardly into the gripping region Z until the lip 20 of the preform is supported axially on the support surface 50 of the fixed head 34, then the finger 54 and the backpiece 32 are each pivoted toward one another so as to clamp the neck 16 of the preform 12 between one another.

According to another alternative embodiment, the backpiece 38 does not have a rib 42, the support surface 40 of the backpiece having a cylindrical concave form with a smooth or ridged surface.

According to this alternative, the backpiece has at its lower axial end a support surface with is supported axially against the main flange 18 when the neck 16 is located in the gripping region Z.

This alternative is particularly suitable for a neck 16 which has no secondary flange 24 and which consequently has no groove 28.

According to another alternative embodiment, with the aim of preventing contaminating particles from entering the inside of the preform 12, the head 34, in its locked position, is arranged so as to close off the opening 22 in the preform 12.

In addition, the closing of the opening 22 makes it possible to sterilize the inside of the preform 12 by way of sterilizing means using hydrogen peroxide (H₂O₂), such as those described in document WO-A-99/03727.

Specifically, this type of sterilizing means injects hydrogen peroxide into the inside of the preform 12, and the hydrogen peroxide is thermally activated by the heat of the furnace heating means, before being eliminated by evaporation.

Thus, the head 34 of the gripping device 10 traps the hydrogen peroxide inside the preform 12 during the heating phase of the preform 12 in the furnace.

According to another alternative embodiment, the head 34 is mounted such that it can move translationally with respect to the backpiece 38 in an oblique direction from the top downward and from the front to the rear.

In a nonlimiting manner, the device 10 according to the invention can be arranged elsewhere than on a device for transporting preforms through the furnace.

The device 10 can be arranged at any point in the installation for blow-molding containers, the device 10 can in particular equip a device for transferring preforms, which is arranged between the furnace and a preform supplying device, or between the furnace and a blow-molding machine.

Similarly, the device 10 can equip a device for transporting formed bottles, upstream of the blow-molding machine.

1. A device (10) for gripping a hollow body (12), the hollow body (12) having a body (14) which is closed at the bottom and a tubular neck (16) which extends axially along an axis (A) and which has a radial annular lip (20) defining an opening (22), the device (10) having:
a backpiece (38) defining a support surface (40) which extends axially,
a head (34) defining a support surface (50) which extends radially and at right angles to the support surface (40) of the backpiece (38),
a locking finger (54) which is carried on the head (34), protrudes axially with respect to the support surface (50) of the head and delimits a counter-support surface (56),
characterized in that the head (34) is mounted such that it can move with respect to the backpiece (38) between at least a position in which the neck (16) is locked, in which the radial support surface (50) of the head (34) is axially supported on at least a portion of the lip (20) of the hollow body (12), the axial support surface (40) of the backpiece (38) is radially supported on the outer surface (26) of the neck (16) and the counter-support surface (56) of the locking finger (54) is supported on an inner surface (58) of the neck (16), such that said support surfaces (40, 50) delimit between one another what is known as a gripping region (Z) for gripping said neck (16), in which the neck (16) is clamped and locked between the backpiece (38) and the locking finger (54), and
a position in which the neck (16) is unlocked, in which the assembly formed by the locking finger (54) and the head (34) is moved apart from the gripping region (Z) in order to unlock the neck (16) and to make it possible to remove and introduce the neck (16) of the hollow body (12) from and/or into the gripping region (Z).

2. The gripping device (10) as claimed in claim 1, characterized in that the head (34) is mounted such that it can pivot with respect to the backpiece (38) about a radial axis (B) at right angles to the backpiece (38).

3. The gripping device (10) as claimed in claim 1, characterized in that the counter-support surface (56) of the finger (54) has a convex form which is supported against the inner surface (58) of the neck (16) of the hollow body (12), opposite the backpiece (38), when the head (34) is in its locked position.

4. The gripping device (10) as claimed in claim 1, characterized in that the locking finger (54) and the head (34) are connected together for the purposes of movement, such that the counter-support surface (56) of the locking finger (54) is automatically supported on the inner surface (58) of the neck (16) when the head (34) is driven from its unlocked position into its locked position.

5. The gripping device (10) as claimed in claim 1, characterized in that, in its locked position, the head (34) is arranged such that it closes off the opening (22) in the neck (16) of the hollow body (12) so as to prevent contaminating particles entering the inside of the hollow body (12).

6. The gripping device (10) as claimed in claim 1, characterized in that the backpiece (38) has a blocking edge (44) which extends radially and is intended to be axially supported against an annular radial flange (24) of the neck (16) when the head (34) is in its locked position, such that the neck (16) is blocked axially between said blocking edge (44) of the backpiece (38) and the support surface (50) of the head (34).

7. The gripping device (10) as claimed in claim 1, characterized in that the backpiece (38) delimits a rib (42) which protrudes radially from the support surface (40) of the backpiece (38), the rib (42) being able to engage with a complementary groove (28) in the neck (16) of the hollow body (12) when the head (34) is in its locked position, such that the groove (28) in the neck (16) is axially blocked by the rib (42) on the backpiece (38).

8. The gripping device (10) as claimed in claim 7, characterized in that the rib (42) on the backpiece (38) has a beveled form having a section that more or less decreases in a radial direction toward the gripping region (Z) in order to enable the rib (42) to be introduced radially into the associated groove (28) in the neck (16).

9. The gripping device (10) as claimed in claim 1, characterized in that the head (34) has means (60) for cooling by dissipation of heat.

10. The gripping device (10) as claimed in claim 1, characterized in that it has actuating means for selectively moving the head (34) between its locked position and its unlocked position.

11. The gripping device (10) as claimed in claim 2, characterized in that the counter-support surface (56) of the finger (54) has a convex form which is supported against the inner surface (58) of the neck (16) of the hollow body (12), opposite the backpiece (38), when the head (34) is in its locked position.

12. The gripping device (10) as claimed in claim 2, characterized in that the locking finger (54) and the head (34) are connected together for the purposes of movement, such that the counter-support surface (56) of the locking finger (54) is automatically supported on the inner surface (58) of the neck (16) when the head (34) is driven from its unlocked position into its locked position.

13. The gripping device (10) as claimed in claim 2, characterized in that, in its locked position, the head (34) is arranged such that it closes off the opening (22) in the neck (16) of the hollow body (12) so as to prevent contaminating particles entering the inside of the hollow body (12).

14. The gripping device (10) as claimed in claim 2, characterized in that the backpiece (38) has a blocking edge (44) which extends radially and is intended to be axially supported against an annular radial flange (24) of the neck (16) when the head (34) is in its locked position, such that the neck (16) is blocked axially between said blocking edge (44) of the backpiece (38) and the support surface (50) of the head (34).

15. The gripping device (10) as claimed in claim 2, characterized in that the backpiece (38) delimits a rib (42) which protrudes radially from the support surface (40) of the backpiece (38), the rib (42) being able to engage with a complementary groove (28) in the neck (16) of the hollow body (12) when the head (34) is in its locked position, such that the groove (28) in the neck (16) is axially blocked by the rib (42) on the backpiece (38).

16. The gripping device (10) as claimed in claim 2, characterized in that the head (34) has means (60) for cooling by dissipation of heat.

17. The gripping device (10) as claimed in claim 2, characterized in that it has actuating means for selectively moving the head (34) between its locked position and its unlocked position.
